(19) United States
(12) Patent Application Publication
(10) Pub. No.: US 2024/0175216 A1
(43) Pub. Date: May 30, 2024

(54) MOLDED FIBER ARTICLES WITH RIBBING STRUCTURES

(71) Applicant: Hewlett-Packard Development Company, L.P., Spring, TX (US)

(72) Inventor: John Joseph BRIDEN, Palo Alto, CA (US)

(21) Appl. No.: 18/284,111

(22) PCT Filed: Apr. 13, 2021
(86) PCT No.: PCT/US2021/027120

§ 371 Date: Sep. 26, 2023

(51) Int. Cl. D21J 5/00; B33Y 50/00; B33Y 80/00; D21F 13/00; G06F 30/17

(52) U.S. Cl. CPC D21J 5/00; B33Y 50/00; B33Y 80/00; D21F 13/00; G06F 30/17

(57) ABSTRACT

According to examples, instructions may cause a processor to determine an intended physical property level that an article is to have when the article is formed, in which the article is to be formed through a molded fiber formation process. The instructions may also cause the processor to determine a thickness and a ribbing structure that the article is to have when the article is formed for the article to have the intended physical property level while a volume of fibers used to form the article is optimized. The instructions may further cause the processor to generate a three-dimensional (3D) digital model of the article to have the determined thickness and ribbing structure.

### BACKGROUND

Various types of products may be fabricated from a pulp of material. Particularly, a pulp molding die that includes a forming mold and a wire mesh may be immersed in the pulp of material and the material in the pulp may form into the shape of the forming mold and the wire mesh. The main body and the wire mesh may have a desired shape of the product to be formed and may thus have a complex shape in some instances. The main body and the wire mesh may include numerous pores for liquid passage, in which the pores in the wire mesh may be significantly smaller than the pores in the main body. During formation of the product, a vacuum force may be applied through the pulp molding die, which may cause the material in the pulp to be sucked onto the wire mesh and form into a shape that matches the shape of the pulp molding die. The material may be removed from the wire mesh and may be solidified to have the desired shape.

### BRIEF DESCRIPTION OF THE DRAWINGS

Features of the present disclosure are illustrated by way of example and not limited in the following figure(s), in which like numerals indicate like elements, in which:

FIG. 1A shows a block diagram of an example computer-readable medium that may have stored thereon computer-readable instructions for generating a 3D digital model of an article, in which the article is to have a thickness and a ribbing structure that is to enable the article to be formed through a molded fiber formation process to have an optimized intended physical property level;

FIG. 1B shows an example diagram, which includes an example processor that may execute the computer-readable instructions stored on the example computer-readable medium shown in FIG. 1A to generate the 3D digital model of the article;

FIGS. 2A and 2B, respectively, depict, cross-sectional side views of an example forming tool and an example transfer tool that may be implemented to form a wet part that is to be formed into the article depicted in FIG. 1B;

FIG. 2C shows a cross-sectional side view of the example forming tool and the example transfer tool shown in FIGS. 2A and 2B during formation of a ribbing structure on a surface of the wet part;

FIG. 2D shows a cross-sectional side view of the example forming tool and the example transfer tool shown in FIGS. 2A and 2B during a removal by the example transfer tool of the wet part from the example forming tool; and

FIG. 3 shows a flow diagram of an example method for generating a 3D digital model of an article having a physical profile that includes a thickness that is smaller than a thickness of a source article and includes a ribbing structure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are non-transitory computer-readable mediums, apparatuses, and methods for generating a 3D digital model of an molded fiber article that is to have a determined thickness and a ribbing structure. Particularly, a processor may determine that the molded fiber article, which is also referenced herein as an article, is to have a certain thickness and a certain ribbing structure that may result in the molded fiber article having an intended physical property level while a volume of fibers used to form the molded article is optimized. The volume of fibers used to form the molded fiber article may be optimized when a minimum volume of fibers is used to form the molded fiber article while the molded fiber article meets intended size and physical property levels. The physical property may be a stiffness of the molded fiber article, a flexibility of the molded fiber article, and/or the like. By minimizing the volume of fibers used to form the articles from molded fibers, the weights of the molded fiber articles may also be reduced, which may increase the use of renewable materials to form the articles and may reduce the carbon footprint impacts of the molded fiber articles.

As discussed herein, the processor may determine a configuration of a ribbing structure to be added to the molded fiber article that may enable the thickness of the article to be minimized while meeting or exceeding the intended physical property level. The ribbing structure may increase the physical property level of the molded fiber article as the ribbing structure may increase a surface area of the molded fiber article. The configurations of the ribbing structure may include a design, a height, a width, and/or the like, of the ribbing structure. The processor may determine the configuration of the ribbing structure based on data corresponding to various ribbing structure configurations and article shapes and sizes. The data may be generated through testing of various ribbing structure configurations and article shapes and sizes, through modeling of various ribbing structure configurations and article shapes and sizes, through simulations of various ribbing structure configurations and article shapes and sizes, through mathematical calculations, and/or the like.

In some examples, the processor may determine multiple combinations of ribbing structure configurations and article thicknesses and may determine the combination that results in the optimized volume of fibers consumption while meeting or exceeding the intended physical property level.

The intended physical property level may be, for instance, a predefined physical property level that the molded fiber article is to have for the molded fiber article to function as intended. By way of example in which the molded fiber article is a tray for holding vegetables, the predefined physical property level may be a physical property level that may enable a certain weight of vegetables to be held on the molded fiber article without breaking. In some examples, the molded fiber article may be modeled after a source molded fiber article that may be formed with a greater volume of fibers than the molded fiber article. That is, the source molded fiber article may be designed to have a certain thickness such that the source molded fiber article may have a certain physical property level. In these examples, the intended physical property level may be equivalent to the certain physical property level. However, the molded fiber article may have a ribbing structure that may enable a thickness of the molded fiber article to be smaller than the thickness of the source molded fiber article while meeting an intended physical property level.

According to examples, the molded fiber article may be formed from a wet part, in which the wet part may be formed in a molded fiber toolset that includes a forming screen and a transfer screen. Particularly, a first surface of the wet part may be in contact with the forming screen and a second surface of the wet part may be in contact with the transfer screen. Either or both of the forming screen and the transfer screen may include an indentation that may correspond to the ribbing structure. In addition, during formation of the wet part from fibers in a slurry of the fibers, a vacuum pressure may be applied through the forming screen to cause the first surface to match the shape and contours of the forming screen. Following formation of the wet part on the forming screen, the forming screen and the wet part may be removed from the slurry and the transfer screen may be positioned near the second surface. A vacuum pressure may be applied through the transfer screen onto the second surface of the wet part to cause the second surface to have the shape and contours of the transfer screen. The molded fiber article may include sections that may have been suctioned into the indentation, in which those sections are to form into the ribbing structure.

Through implementation of the features of the present disclosure, a 3D digital model of an article to be fabricated through a molded fiber fabrication process may be generated, in which a minimized volume of fibers may be consumed in the fabrication of the article while the article meets or exceeds an intended physical property level. The 3D digital model of the article may be employed to generate 3D digital models of forming screens and/or transfer screens that may be implemented in the formation of the article from fibers.

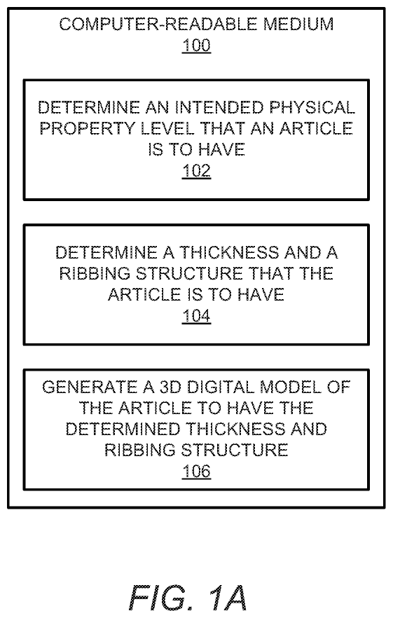

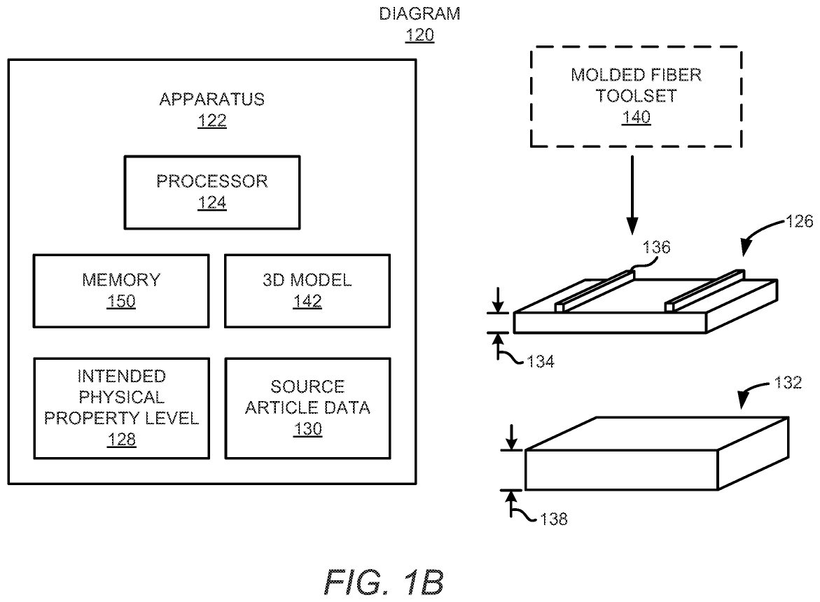

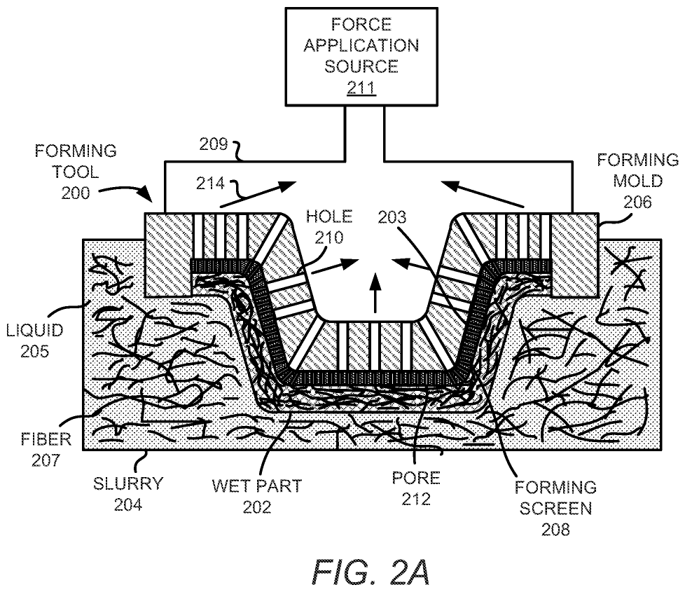

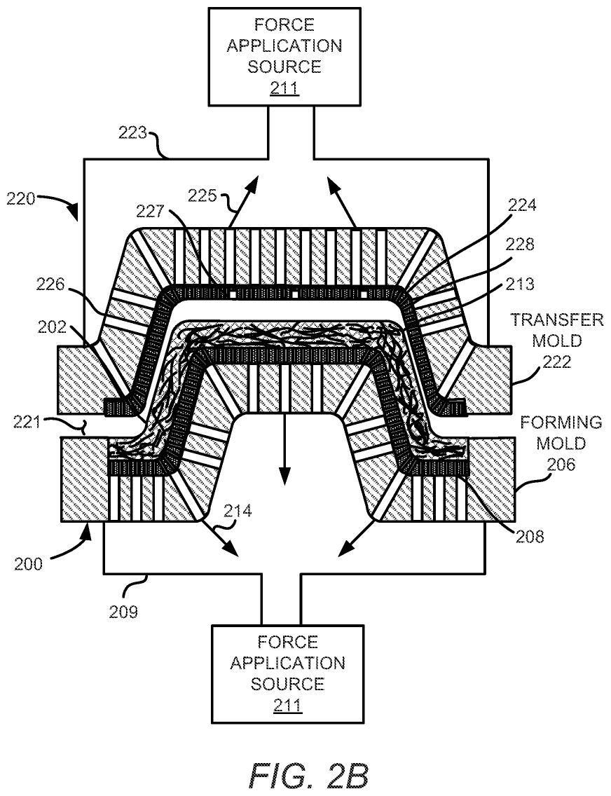

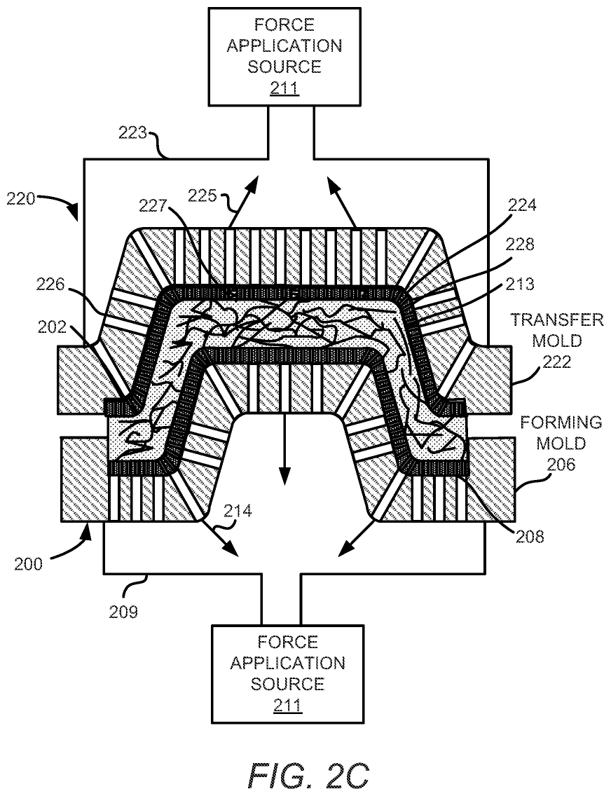

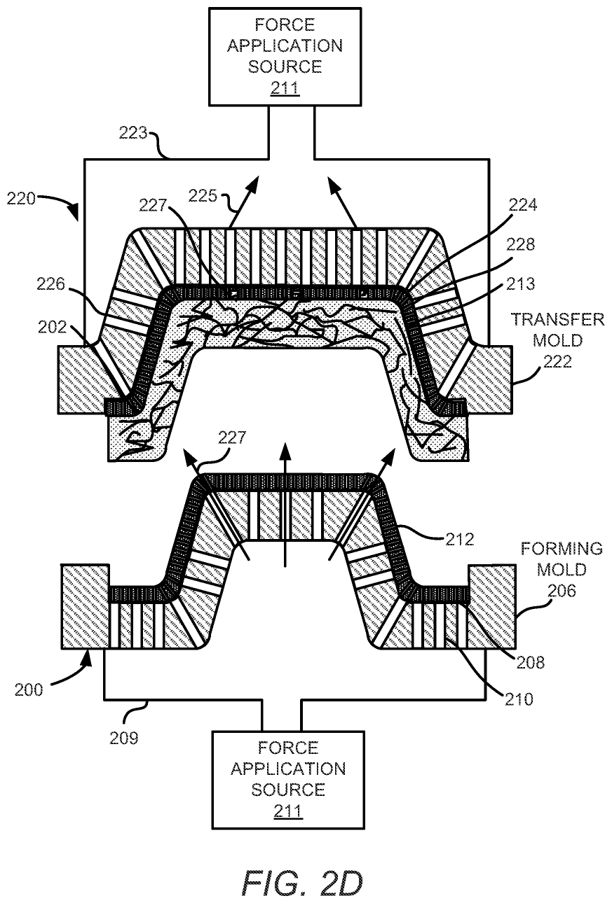

Reference is first made to FIGS. 1A-2D. FIG. 1A shows a block diagram of an example computer-readable medium 100 that may have stored thereon computer-readable instructions for generating a 3D digital model of an article, in which the article is to have a thickness and a ribbing structure that is to enable the article to be formed through a molded fiber formation process to have an optimized intended physical property level. FIG. 1B shows an example diagram 120, which includes an example processor 124 that may execute the computer-readable instructions stored on the example computer-readable medium 100 shown in FIG. 1A to generate the 3D digital model of the article.

FIGS. 2A and 2B, respectively, depict, cross-sectional side views of an example forming tool 200 and an example transfer tool 220 that may be implemented to form a wet part 202 that is to be formed into the article 126 depicted in FIG. 1B. FIG. 2C shows a cross-sectional side view of the example forming tool 200 and the example transfer tool 220 during formation of a ribbing structure 136 on a surface of the wet part 202. FIG. 2D shows a cross-sectional side view of the example forming tool 200 and the example transfer tool 220 during a removal by the example transfer tool 220 of the wet part 202 from the example forming tool 200.

It should be understood that the example computer-readable medium 100 depicted in FIG. 1A, the example diagram 120 depicted in FIG. 1B, or the example forming tool 200 depicted in FIGS. 2A, 2C, and 2D, and/or the example transfer tool 220 depicted in FIGS. 2B-2D may include additional attributes and that some of the attributes described herein may be removed and/or modified without departing from the scopes of the example computer-readable medium 100, the example diagram 120, the example forming tool 200, and the example transfer tool 220.

With reference first to FIG. 1A, the computer-readable medium 100 may have stored thereon computer-readable instructions 102-106 that a processor, such as the processor 124 depicted in FIG. 1B, may execute. The computer-readable medium 100 may be an electronic, magnetic, optical, or other physical storage device that contains or stores executable instructions. The computer-readable medium 100 may be, for example, Random Access memory (RAM), an Electrically Erasable Programmable Read-Only Memory (EEPROM), a storage device, an optical disc, and the like. Generally speaking, the computer-readable medium 100 may be a non-transitory computer-readable medium, in which the term “non-transitory” does not encompass transitory propagating signals.

The processor 124 may fetch, decode, and execute the instructions 102 to determine an intended physical property level 128 that an article 126 is to have when the article 126 is formed. As discussed herein, the article 126 may be formed through a molded fiber formation process and may thus be formed of molded fibers from a slurry of the fibers. The slurry of the fibers may include a liquid, which may be water or another type of suitable liquid in which fibers may be mixed into the slurry. The fibers in the slurry, which may also be construed as a pulp material, may be fibers of paper, wood, fibrous crops, bamboo, and/or the like. The article 126 may be any suitable type of article that may be formed from a slurry of the fibers. For instance, the article 126 may be a tray for holding items, a packaging container for an electronic device, a packaging container for an item, a container for vegetables, a face mask, and/or the like.

According to examples, the intended physical property level 128 that the article 126 is to have when fabricated may be based on the type of application that the article 126 is to undergo during use. For instance, the intended physical property level 128 may be higher for articles 126 that are to support larger and/or heavier items. Likewise, the intended physical property level 128 may be lower for articles 126 that are to support smaller and/or lighter items. The intended physical property level 128 may be, for instance, a stiffness, a strength, a rigidity, an elasticity, and/or the like, of the article 126. By way of example, the intended physical property level 128 may be relatively higher for articles 126 that are to span larger distances. In some examples, the intended physical property level 128 of the article 126 may be provided to the processor 124 from a user or other source.

In other examples, the processor 124 may determine the intended physical property 128 based on an analysis of data 130 of a source article 132, which may also be referenced herein as source article data 130. The source article 132 may be a version of the article 126 that may not be optimized to consume a minimized volume of fibers. In other words, the source article 132 may be a standard or original form of the article 126 prior to the article 126 being modified to consume a minimized volume of fibers.

The source article data 130 may include data pertaining to a source article 132, such as dimensions of the source article 132, a shape or contour of the source article 132, a volume of fibers predicted to be used to form the source article 132, and/or the like. According to examples, the source article data 130 may be a 3D digital model of the source article 132, e.g., a CAD model, or the like. In other examples, the source article data 130 may be in any of other forms that the processor 124 may read. In any of these examples, the processor 124 may obtain the source article data 130, for instance, from a user, from a data store, and/or the like.

The processor 124 may determine a volume of fibers to be used in a formation of the source article 132 based on the source article data 130. For instance, the processor 124 may use any of various information in the source article data 130 to make this determination. In some examples, the source article data 130 may include the volume of fibers information. As another example, the processor 124 may calculate the volume of fibers to be consumed in the formation of the source article 132 from the volume of the source article 132 identified in the source article data 130. In these examples, the processor 124 may calculate the volume of fibers based on a known concentration of fibers per unit volume and the volume of the source article 132.

The processor 124 may also calculate, based on the determined volume of fibers to be used in the formation of the source article 132, a physical property level that the source article 132 is to have following formation of the source article 132 through a molded fiber formation process. The processor 124 may calculate the physical property level that the source article 132 is to have based on, for instance, dimensions of the source article 132, a density at which the fibers are to be arranged in the source article 132, the type of fiber material, and/or the like. By way of particular example in which the physical property is a stiffness of the source article 132, the stiffness of the source article 132 may be defined by its moment of inertia (BH³/12), in which B is the width of the source article 132 and H is the cross-sectional height in the direction of flexure of the source article 132. In some examples, the processor 124 may determine the intended physical property level 128 to be the calculated physical property level of the source article 132.

The processor 124 may fetch, decode, and execute the instructions 104 to determine a thickness 134 and a ribbing structure 136 that the article 126 is to have when the article 126 is formed for the article 126 to have the intended physical property level 128 while a volume of fibers used to form the article 126 is optimized. For instance, the processor 124 may determine the thickness 134 and the ribbing structure 136 that the article 126 is to have when the article 126 is formed while the volume of fibers used to form the article 126 is minimized with respect to the determined volume of fibers to be used in the formation of the source article 132 based on the source article data 130.

Particularly, for instance, the addition of the ribbing structure 136 to a surface of the article 126 may increase the physical property, e.g., stiffness of the article 126. The physical property of the article 126 may be increased through addition of the ribbing structure 136 because the ribbing structure 136 may increase the surface area of the article 126. In many instances, the stiffness and/or strength of a molded fiber article may depend on the shape in which the fibers in the skin, e.g., outer surface, of the article 126 is contoured. As a result, the addition of the ribbing structure 136 onto the article 126 may enable the thickness 134 of the article 126 to be reduced while maintaining or exceeding the intended physical property level 128. The ribbing structure 136 may include any suitable configuration, such as a linear structure, a curved structure, a hexagonal structure, and/or the like. For instance, although the ribbing structure 136 has been depicted as having a linear structure in FIG. 1B, it should be understood that the ribbing structure 136 may have other structures, such as a two-dimensional structure, e.g., a crisscross pattern, a honeycomb structure, and/or the like.

According to examples, the processor 124 may access data pertaining to the level of increase in the physical property level variously sized and shaped ribbing structures formed of molded fibers may provide to articles. This data may be based on testing of various types of molded fibers as well as variously sized and shaped ribbing structures. This data may also or alternatively be determined through modeling, mathematical calculations, and/or simulations. In any of these examples, the processor 124 may determine the thickness 134 and the ribbing structure 136 to be a thickness 134 and a ribbing structure 136 that minimizes the volume of fibers to be consumed in forming the article 126 while the article 126 may be formed to have the intended physical property level 128 or a higher physical property level. The processor 124 may make this determination through analysis of multiple combinations of thicknesses 134 and ribbing structures 136. The minimized volume of fibers may correspond to the combination of thicknesses 134 and ribbing structures 136 in the analyzed combination of thicknesses 134 and ribbing structures 136 having the minimized volume of fibers while meeting the intended physical property level 128.

As shown in FIG. 1B, the source article 132 may have a first thickness 138. In addition, the article 126 may have a second thickness 134 that is relatively smaller than the first thickness 138 while other dimensions of the article 126 may remain equivalent to the source article 132. In this regard, the volume of the article 126 may be relatively smaller than the volume of the source article 132. As such, the volume of fibers to be consumed to form the article 126 may be relatively smaller than the volume of fibers to be consumed to form the source article 132.

According to examples, a molded fiber toolset 140 may form a wet part 202 that is to form into the article 126 when the wet part 202 is dried. It should be noted that the wet part 202 has been depicted as having a different shape and contours than the article 126 for purposes of simplicity of illustration. In other examples, the wet part 202 and the article 126 may have the same shape and contours. The molded fiber toolset 140 may include, among other components, a forming screen 208 (FIG. 2A) and a transfer screen 224 (FIG. 2B). With particular reference to FIG. 2A, the article 126 may be formed from a wet part 202 composed of fibers 207 in a slurry 204 of the fibers 207. The slurry 204 of the fibers 207 may include a liquid 205, which may be water or another type of suitable liquid in which fibers 207 may be mixed into the slurry 204. The fibers 207 in the slurry 204, which may also be construed as a pulp material, may be fibers of paper, wood, fibrous crops, bamboo, and/or the like.

As show in FIG. 2A, the wet part 202 may be formed from the slurry 204 of the fibers 207 on the forming screen 208. The wet part 202 may include a first surface 203 that is in contact with the forming screen 208. The forming screen 208 may be part of a forming tool 200, which may also include a forming mold 206. The forming screen 208 may be mounted onto the forming mold 206 and the forming mold 206 and the forming screen 208 may have shapes to which the wet part 202 may be molded when formed on the forming screen 208.

As shown, the forming mold 206 may have a relatively larger thickness than the forming screen 208. The larger thickness of the forming mold 206 may cause the forming mold 206 to be substantially more rigid than the forming screen 208. The forming mold 206 may provide structural support for the forming screen 208. By way of particular non-limiting example, the forming screen 208 may have a thickness in the range of about 1 mm and 2 mm and the forming mold 206 may have a thickness in the range of about 5-8 mm. The thicknesses of the forming screen 208 and/or the forming mold 206 may be based on, for instance, characteristics of the molded fiber part, characteristics of the fiber 207, processes that the forming tool 200 is to undergo, and/or the like. The characteristics may include the type of the fiber 207 in the slurry 204, the concentration of the fiber 207 in the slurry 204, the sizes of the fiber 207 in the slurry 204, the pressures applied through the forming tool 200 during formation of the wet part 202, the lengths and widths of the forming tool 200, and/or the like. The thicknesses of the forming mold 206 and/or the forming screen 208 may thus vary for different types of forming machines and applications.

As also shown, the forming mold 206 may include holes 210 and the forming screen 208 may include pores 212, in which the holes 210 may have diameters that are larger than the diameters of the pores 212. For instance, the diameters of the holes 210 may be larger than the sizes of the fibers 207 whereas the diameters of the pores 212 may be smaller than the sizes of the fibers 207. That is, the pores 212 may have sufficiently small dimensions, e.g., diameters or widths, that may enable the liquid 205 to flow through the pores 212 while blocking the fibers 207 from flowing through the pores 212. In one regard, the diameters or widths of the pores 212 may be sized based on sizes of the fibers 207 in the slurry 204, e.g., the diameters of the pores 212 may be smaller than the sizes of the fibers 207. By way of particular non-limiting example, the pores 212 may have diameters of around 0.6 mm and the holes 210 may have diameters of around 2 mm. However, in some instances, the pores 212 and/or the holes 210 may have irregular shapes as may occur during 3D fabrication processes and/or other shapes, such as hexagons, pentagons, triangles, etc.

According to examples, to form the wet part 202 on the forming screen 208, the forming screen 208 and the forming mold 206 may be immersed or otherwise inserted into a volume of the slurry 204. In some examples, the forming mold 206 may be mounted onto a supporting structure (not shown), in which the supporting structure may be movable with respect to the slurry 204. The supporting structure may move the forming tool 200 into the slurry 204, for instance, as shown in FIG. 2A

The forming tool 200 may be in communication with a plenum 209 to which a force application source 211 may be connected. The force application source 211 may be a vacuum device that may apply a vacuum pressure through the holes 210 in the forming mold 206 and the pores 212 in the forming screen 208. When the vacuum pressure is applied through the holes 210 and the pores 212, some of the liquid 205 in the slurry 204 may be suctioned through the holes 210 and the pores 212 and may flow into the plenum 209 as denoted by the arrows 214. As the liquid 205 flows through the holes 210 and the pores 212, the forming screen 208 may prevent the fibers 207 in the slurry 204 from flowing through the pores 212. As discussed herein, the force application source 211 may also be a blowing force device that may cause a blowing force to be applied through the holes 210 and the pores 212. In some examples, the airflow output by the force application source 211 may be reversible to cause the airflow to apply a vacuum force or a blowing force.

Over a period of time, which may be a relatively short period of time, e.g., about a few seconds, less than about a minute, less than about five minutes, or the like, the fibers 207 may build up on the forming screen 208. Particularly, the fibers 207 in the slurry 204 may be accumulated and compressed onto the forming screen 208 into the wet part 202 as shown in FIG. 2A. As the fibers 207 are accumulated, the wet part 202 may take the shape of the forming screen 208 and may have a relatively smooth first surface 203. The thickness and density of the wet part 202 may be affected by the types and/or sizes of the fibers 207 in the slurry 204, the length of time that the vacuum pressure is applied while the forming mold 206 and the forming screen 208 are placed within the volume of the slurry 204, etc. That is, for instance, the wet part 202 may be formed to have a greater thickness the longer that the vacuum pressure is applied while the forming mold 206 and the forming screen 208 are partially immersed in the slurry 204.

After the period of time, e.g., after the wet part 202 having desired properties, e.g., thickness, density, porosity of the fibers 207, concentration of the fibers 207, and/or the like, has been formed on the forming screen 208, the forming mold 206 and the forming screen 208 may be removed from the volume of slurry 204. For instance, a supporting structure onto which the forming tool 200 may be mounted may move the forming tool 200 away from the volume of slurry 204. In some examples, the supporting structure may rotate with respect to the volume of slurry 204 such that rotation of the movable mechanism may cause the forming mold 206 and the forming screen 208 to be removed from the volume of slurry 204. In other examples, the supporting structure may be moved laterally with respect to the volume of slurry 204. As the forming mold 206 and the forming screen 208 are removed from the volume, some of the excess slurry 204 may come off of the wet part 202. However, the wet part 202 may have a relatively high concentration of liquid 205.

Following the formation of the wet part 202 on the forming screen 208 and movement of the forming screen 208 and the wet part 202 out of the volume of slurry 204, a transfer screen 224 of a transfer tool 220 may be positioned near a second surface 213 of the wet part 202, for instance, as shown in FIG. 2B. Although not shown, the transfer mold 222 may be supported on a movable supporting structure that may move the transfer tool 220 with respect to the forming tool 200.

As shown in FIG. 2B, and according to examples, the transfer screen 224 may be moved to a position that is a predefined distance away from the forming screen 208, e.g., such that a gap 221 may exist between a bottom surface of the transfer screen 224 and the second surface 213. The predefined distance may correspond to an intended amount of decrease in the density at which the fibers 207 are to be arranged in the wet part 202. Equivalently, the predefined distance may correspond to a distance that the second surface 213 is to traverse in order for an article 126 formed from the wet part 202 to have an intended porosity level to function as a filter that may filter out an intended percentage of airborne particulates. The predefined distance may be determined through testing, modeling, simulations, and/or the like. In other examples, however, the transfer screen 224 may be positioned such that the transfer screen 224 is in contact with the wet part 202. In these examples, the wet part 202 may not undergo a substantial expansion through application of a vacuum force onto the second surface 213 of the wet part 202 through the transfer screen 224.

As shown in FIG. 2B, the transfer tool 220 may also include a transfer mold 222, which may have a relatively larger thickness than the transfer screen 224. The larger thickness of the transfer mold 222 may cause the transfer mold 222 to be substantially more rigid than the transfer screen 224. The transfer mold 222 may provide structural support for the transfer screen 224. By way of particular non-limiting example, the transfer screen 224 may have a thickness in the range of about 1 mm and 2 mm and the transfer mold 222 may have a thickness in the range of about 5-8 mm. The thicknesses of the transfer screen 224 and/or the transfer mold 222 may be based on, for instance, characteristics of the molded fiber part processes that the transfer tool 220 is to undergo and may be similar to those listed above with respect to the forming mold 206 and the forming screen 208.

As also shown in FIG. 2B, the transfer mold 222 may include holes 226 and the transfer screen 224 may include pores 228, in which the holes 226 may have diameters that are larger than the diameters of the pores 228. For instance, the diameters of the holes 226 may be larger than the sizes of the fibers 207 whereas the diameters of the pores 228 may be smaller than the sizes of the fibers 207. That is, the pores 228 may have sufficiently small dimensions, e.g., diameters or widths, that may enable the liquid 205 to flow through the pores 228 while blocking the fibers 207 from flowing through the pores 228. In one regard, the diameters or widths of the pores 228 may be sized to be smaller than the sizes of the fibers 207 in the slurry 204. By way of particular non-limiting example, the pores 228 may have diameters of around 0.6 mm and the holes 226 may have diameters of around 2 mm. In some instances, the pores 228 and/or the holes 226 may have irregular shapes as may occur during 3D fabrication processes and/or other shapes, such as hexagons, pentagons, triangles, etc.

According to examples, a three-dimensional (3D) fabrication system may fabricate the forming screen 208 and/or the transfer screen 224. The 3D fabrication system (not shown) may be any suitable type of additive manufacturing system. Examples of suitable additive manufacturing systems may include systems that may employ curable binder jetting onto build materials (e.g., thermally or UV curable binders), print agent jetting onto build materials (e.g., fusing and/or detailing agents), selective laser sintering, stereolithography, fused deposition modeling, etc. In a particular example, the 3D fabrication system may form the forming screen 208 and/or the transfer screen 224 by binding and/or fusing build material particles together. In any of these examples, the build material particles may be any suitable type of material that may be employed in 3D fabrication processes, such as, a metal, a plastic (such as a nylon), a ceramic, an alloy, and/or the like. Generally speaking, higher functionality/performance forming and transfer screens 208, 224 may be those with the smallest pore size to block fibers 207 of smaller sizes, and hence some 3D fabrication system technologies may be more suited for generating the forming and transfer screens 208, 224 than others.

With reference to FIGS. 1 and 2C, the second surface 213 of the wet part 202 may be pulled away from the first surface 203 of the wet part 202 while a suction force is applied onto the first surface 203 through the pores 212 in the forming screen 208 to cause a density at which the fibers are arranged in the wet part 202 to be decreased. As shown in FIG. 2B, the transfer tool 220 may be in communication with a plenum 223 to which the force application source 211 may be connected such that the force application source 211 may apply a vacuum pressure through the holes 226 in the transfer mold 222 and the pores 228 in the transfer screen 224. Although a common force application source 211 is depicted in FIG. 2C as applying vacuum force to both of the plenums 209, 223, it should be understood that force may be applied to the plenum 223 by a separate force application source.

As shown in FIG. 2C, the force application source 211 may apply vacuum force, or equivalently, a suction force, to both of the plenums 209, 223 such that the vacuum force may be applied to both of the first and second surfaces 203, 213 of the wet part 202. That is, the first surface 203 may be pulled to remain in contact with the forming screen 208 and the second surface 213 may be pulled to be in contact with the transfer screen 224. In this regard, the second surface 213, as well as some of the fibers 207 in the wet part 202 may be pulled toward the transfer screen 224 to cause the gap 221 to be filled by the wet part 202. The expansion of the wet part 202 may result in the density at which the fibers 207 are arranged in the wet part 202 to be decreased. In other words, the expansion of the wet part 202 may result in the fibers 207 in the wet part 202 to be more spaced apart from each other as compared with the arrangement of the fibers 207 prior to the vacuum force being applied on the second surface 213 of the wet part 202.

In other examples, following formation of the wet part 202 on the forming screen 208, the transfer screen 224 may be brought into contact with the second surface 213 of the wet part 202. In these examples, the transfer screen 224 may be moved the predefined distance that corresponds to the intended amount of decrease in the density at which the fibers 207 are arranged in the wet part 202 while the vacuum pressure is applied onto the second surface 213 of the wet part 202 to pull the second surface 213 and while the vacuum pressure is applied onto the first surface 203 of the wet part 202.

As shown in FIGS. 2B and 2C, the transfer screen 224 may include a number of indentations 227 that may correspond to a shape of the ribbing structure 136. As the vacuum force is applied onto the second surface 213 of the wet part 202, some of the fibers 207 in the wet part 202 may be suctioned into the indentations 227 such that the article 126 may be formed with the ribbing structure 136. The ribbing structure 136 may thus be formed on the article 126 without increasing the volume of fibers 207 consumed to form the article 126. In some examples, the thickness of the wet part 202 may remain the same during application of the vacuum pressure on the first and second surfaces 203, 213. In some examples the ribbing structure 136 and/or an additional ribbing structure 136 may be formed on the first surface 203 in similar manners.

Application of the vacuum pressure on the second surface 213 of the wet part 202 may also result in some of the liquid 205 in the wet part 202 being removed from the wet part 202 through the second surface 213 as denoted by the arrows 225. Likewise, application of the vacuum pressure on the first surface 203 of the wet part 202 may result in some of the liquid 205 in the wet part 202 being removed from the wet part 202 through the first surface 203 as denoted by the arrow 214. As a result, the application of the vacuum pressures on the first and second surfaces 203, 213 may result in the wet part 202 being partially de-watered. The partial de-watering of the wet part 202 may cause the fibers 207 to remain, or equivalently, to be set, in their reduced density arrangements. In addition, by partially de-watering the wet part 202, the amount of energy used to fully dry the wet part 202 following removal of the wet part 202 from the transfer screen 224, such as in an oven, may significantly be reduced as discussed herein.

Application of the vacuum pressure on the second surface 213 of the wet part 202 through the transfer screen 224 may further result in the second surface 213 having a contour that matches the contour of the transfer screen 224. In addition, the second surface 213 may be caused to have a relatively smooth surface. In some examples, the second surface 213 may have a smoothness that is equivalent to the smoothness of the first surface 203. In other words, the second surface 213 may have a smoothness that is similar, e.g., within a certain level of difference, to the smoothness of the first surface 203.

Following a predefined length of time after initiation of the pulling of the second surface 213 away from the first surface 203, the wet part 202 may be removed from the forming screen 224, as shown in FIG. 2D. The predefined length of time may correspond to a length of time during which the vacuum force may be applied onto both the first and second surfaces 203, 213 of the wet part 202 to cause the fibers 207 in the wet part 202 to remain at an expanded state following removal of the vacuum forces. In other words, the predefined length of time may correspond to a length of time that may cause the wet part 202 to be partially dewatered and the fibers 207 in the wet part 202 to partially be set in place. The predefined length of time may depend upon any of a number of factors, such as the concentration of the liquid 205 in the wet part 202, the density at which the fibers 207 are arranged in the wet part 202, the amount of vacuum force applied, and/or the like. In addition, the predefined length of time may be determined through testing, modeling, simulations, and/or the like.

To remove the wet part 202 from the forming screen 208, the force application source 211 may continue to apply the vacuum force onto the wet part 202 through the transfer tool 220 while the transfer tool 220 is moved in a direction away from the forming tool 200. In addition, the force application source 211 may cease application of the vacuum force through the forming tool 200 while the transfer tool 220 is moved away from the forming tool 200. In other examples, and as shown in FIG. 2D, the force application source 211 may cause a blowing force to be applied through the pores 212 of the forming screen 208 to push the wet part 202 off of the forming screen 208 toward the transfer screen 224.

The force application source 211 may continue to cause the vacuum force to be applied onto the wet part 202 while the transfer tool 220 is continued to be moved away from the forming tool 200. When the transfer tool 220 reaches a certain destination, such as a location corresponding to a next phase in a process of forming an article from the wet part 202, the transfer tool 220 may release the wet part 202 from the transfer screen 224. For instance, the transfer tool 220 may transfer the wet part 202 from the forming tool 200 to an oven (not shown) or a conveyor that may carry the wet part 202 to an oven. To release the wet part 202 from the transfer screen 224, the force application source 211 may cease application of the vacuum force onto the wet part 202. In some examples, the force application source 211 may cause a blowing force to be applied through the transfer tool 220 to push the wet part 202 off of the transfer screen 224.

According to examples, a pressing operation onto the wet part 202 may not be performed during or following transfer of the wet part 202 from the forming tool 200. For instance, an operation to squeeze additional liquid 205 from the wet part 202 may not be performed as such an operation may compress the fibers 207 in the wet part 202 and cause the fibers 207 in the wet part 202 to be more densely packed with respect to each other. However, in some examples, a localized pressing operation may be performed on a section of the wet part 202 at which the ribbing structure 136 is not located.

According to examples, an article 126 may be formed from the wet part 202 following drying of the wet part 202 in an oven or other drying device. In other examples, the wet part 202 may be dried naturally, e.g., by being placed in a dry environment for a period of time. The article 126 may include the ribbing structure 136 when the article 126 is formed.

The processor 124 may fetch, decode, and execute the instructions 106 to generate a three-dimensional (3D) digital model 142 of the article 126 to have the determined thickness 134 and ribbing structure 136. The processor 124 may generate the 3D digital model 142 of the article 126 as a computer aided design (CAD) file, a 3D manufacturing format (3MF) file, or other digital representation of the article 126. In some examples, the source article data 130 may be a 3D digital model of the source article 132. In these examples, to generate the 3D digital model 142 of the article 132, the processor 124 may modify the 3D digital model of the source article 132 to have the determined thickness 134 and ribbing structure 136.

In some examples, the 3D digital model 142 of the article 126 may be used to generate 3D digital models of the forming screen 208 and the transfer screen 224. The forming screen 208 and the transfer screen 224 may be fabricated, for instance, via 3D fabrication operations, based on the generated 3D digital models such that the forming screen 208 and the transfer screen 224 may be employed in a molded fiber operation to form the wet part 202 from which the article 126 having the thickness 134 and the ribbing structure 136 may be formed.

In some examples, the processor 124 may be part of an apparatus 122, which may be a computing system such as a server, a laptop computer, a tablet computer, a desktop computer, or the like. The processor 124 may be a semiconductor-based microprocessor, a central processing unit (CPU), an application specific integrated circuit (ASIC), a field-programmable gate array (FPGA), and/or other suitable hardware device. The apparatus 122 may also include a memory 150, which may be equivalent to the computer-readable medium 100 depicted in FIG. 1A, that may have stored thereon computer-readable instructions (which may also be termed computer-readable instructions) that the processor 124 may execute.

For instance, the memory 150 may have stored thereon machine-readable instructions that when executed by the processor 124, may cause the processor 124 to determine an intended physical property level 128 for an article 126 to be formed through a molded fiber formation process. The instructions may also cause the processor 124 to determine a physical profile for the article 126, in which the physical profile may identify a thickness 134 and a ribbing structure 136 that the article 126 is to have to cause the article 126 to have at least the intended physical property level 128 while minimizing a volume of fibers used to form the article 126. The instructions may further cause the processor 124 to generate a 3D digital model 142 of the article 126 to have the determined physical profile.

The instructions may still further cause the processor 124 to obtain data 130 of a source article 132, determine a volume of fibers to be used in a formation of the source article 132, calculate, based on the determined volume of fibers, a physical property level that the source article 132 is to have following formation of the source article 132 through a molded fiber formation process, and determine the intended physical property level 128 to be the calculated physical property level.

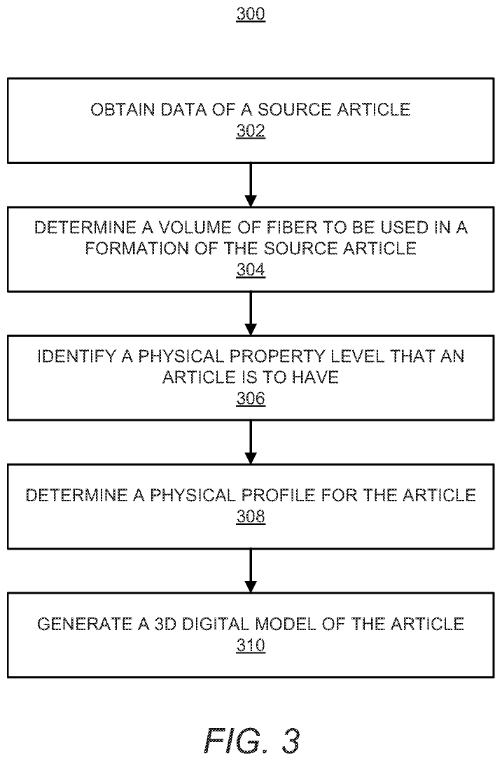

Reference is now made to FIG. 3, which shows a flow diagram of an example method 300 for generating a 3D digital model 142 of an article 126 having a physical profile that includes a thickness that is smaller than a thickness of a source article 132 and includes a ribbing structure 136. It should be understood that the example method 300 may include additional attributes and that some of the attributes described herein may be removed and/or modified without departing from the scope of the method 300. The description of the method 300 is made with reference to the features depicted in FIGS. 1-2D.

At block 302, the processor 124 may obtain data of a source article (source article data 130), in which the source article 132 may have a first thickness 138. At block 304, the processor 124 may determine a volume of fibers to be used in a formation of the source article 132 based on the source article data 130. At block 306, the processor 124 may identify, based on the determined volume of fibers, a physical property level 128 that an article 126 is to have following formation of the article 126 through a molded fiber formation process.

At block 308, the processor 124 may determine a physical profile for the article 126 that includes a second thickness 134 that is smaller than the first thickness 138 and a ribbing structure 136 extending from a surface of the article 126, the physical profile to cause the article 126 to meet or exceed the identified physical property level 128 while consuming a smaller volume of fibers. In some examples, the processor 124 may determine the physical profile for the article 126 to be a physical profile that minimizes the volume of fibers consumed in forming the article 126 while meeting or exceeding the identified physical property level 128 that the source article 132 is to have when formed according to the source article data 130. At block 310, the processor 124 may generate a 3D digital model 142 of the article 126 corresponding to the article 126 having the physical profile.

In some examples, the processor 124 may cause a molded fiber toolset 140 to fabricate the article 126 based on the 3D digital model 142. As discussed herein, the molded fiber toolset 140 may include a forming screen 208 and a transfer screen 224, in which a vacuum force is to be applied through the forming screen 208 and the transfer screen 224 onto opposite surfaces of a wet part 202 formed on the forming screen 208. As also discussed herein, the wet part 202 may be formed into the article 126 when the wet part 202 is dried. The transfer screen 224 may include an indentation 227 corresponding to a shape of the ribbing structure 136, in which application of the vacuum force through the transfer screen 224 may cause the ribbing structure 136 to be formed from some of the fibers in the wet part 202 being suctioned into the indentation 227.

In some examples, the processor 124 may generate a 3D digital model of either or both of the forming screen 208 and the transfer screen 224 to be used in the molded fiber toolset 140 to fabricate the wet part 202 that is to form into the article 126 having the physical profile. That is, the processor 124 may generate the 3D digital model of either or both of the forming screen 208 and the transfer screen 224 to have shapes and contours that correspond to the shapes and contours of the article 126. For instance, the 3D digital model of either or both of the forming screen 208 and the transfer screen 224 to include indentations 227 corresponding to the ribbing structure 136 on the article 126.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A non-transitory computer-readable medium on which is stored machine-readable instructions that when executed by a processor, cause the processor to:
determine an intended physical property level that an article is to have when the article is formed, the article to be formed through a molded fiber formation process;
determine a thickness and a ribbing structure that the article is to have when the article is formed for the article to have the intended physical property level while a volume of fibers used to form the article is optimized; and
generate a three-dimensional (3D) digital model of the article to have the determined thickness and ribbing structure.

2. The non-transitory computer-readable medium of claim 1, wherein the instructions cause the processor to:
obtain data of a source article;
determine a volume of fibers to be used in a formation of the source article based on the source article data;
calculate, based on the determined volume of fibers, a physical property level that the source article is to have following formation of the source article through a molded fiber formation process; and
determine the intended physical property level to be the calculated physical property level.

3. The non-transitory computer-readable medium of claim 2, wherein the instructions cause the processor to:
determine the thickness and the ribbing structure that the article is to have when the article is formed while the volume of fibers used to form the article is minimized with respect to the determined volume of fibers to be used in the formation of the source article based on the source article data.

4. The non-transitory computer-readable medium of claim 2, wherein the source article data comprises a 3D digital model of the source article, and wherein the instructions cause the processor to:
modify the 3D digital model of the source article to have the determined thickness and ribbing structure to generate the 3D digital model of the article.

5. The non-transitory computer-readable medium of claim 1, wherein the instructions cause the processor to:
determine the thickness and the ribbing structure that the article is to have based on the article being formed from a wet part composed of fibers in a slurry of the fibers, wherein a forming screen is to contact a first surface of the wet part and a transfer screen is to contact a second surface of the wet part during formation of the wet part.

6. The non-transitory computer-readable medium of claim 1, wherein the instructions cause the processor to:
determine the thickness and the ribbing structure that the article is to have based on the article being formed from a wet part composed of fibers in a slurry of the fibers, wherein, during formation of the wet part,
a forming screen is to be immersed in a volume of a slurry of fibers and a suction force is to be applied through the forming screen to cause a first surface of a wet part to be in contact with the forming screen; and
following formation of the wet part on the forming screen, a suction force may be applied through a transfer screen onto a second surface of the wet part to form the ribbing structure on the second surface of the wet part.

7. The non-transitory computer-readable medium of claim 6, wherein the suction force applied through the transfer screen onto the second surface of the wet part is to cause a density at which the fibers forming the ribbing structure to be decreased.

8. The non-transitory computer-readable medium of claim 6, wherein the suction force applied through the transfer screen onto the second surface of the wet part is to cause a density at which the fibers forming the article including the ribbing structure to be decreased.

9. A method comprising:
obtaining, by a processor, data of a source article, the source article to have a first thickness;
determining, by the processor, a volume of fibers to be used in a formation of the source article based on the source article data;
identifying, by the processor, based on the determined volume of fibers, a physical property level that an article is to have following formation of the article through a molded fiber formation process;
determining, by the processor, a physical profile for the article that includes a second thickness that is smaller than the first thickness and a ribbing structure extending from a surface of the article, the physical profile to cause the article to meet or exceed the identified physical property level while consuming a smaller volume of fibers; and
generating, by the processor, a 3D digital model of the article corresponding to the article having the physical profile.

10. The method of claim 9, further comprising:
causing a molded fiber toolset to fabricate the article based on the 3D digital model, wherein the molded fiber toolset includes a forming screen and a transfer screen, wherein a vacuum force is to be applied through the forming screen and the transfer screen onto opposite surfaces of a wet part formed on the forming screen, and wherein the wet part is to form into the article when the wet part is dried.

11. The method of claim 10, further comprising:
generating a 3D digital model of either or both of the forming screen and the transfer screen to be used in the molded fiber toolset to fabricate the wet part that is to form into the article having the physical profile.

12. The method of claim 10, wherein the transfer screen includes an indentation corresponding to a shape of the ribbing structure, wherein application of the vacuum force through the transfer screen is to cause the ribbing structure to be formed from some of the fibers in the wet part being suctioned into the indentation.

13. The method of claim 9, wherein determining the physical profile for the article comprises:
determining the physical profile for the article to be a physical profile for the article that minimizes the volume of fibers consumed in forming the article while meeting or exceeding the identified physical property level that the source article is to have when formed according to the source article data.

14. An apparatus comprising:
a processor; and
a memory on which is stored machine-readable instructions that when executed by a processor, cause the processor to:
determine an intended physical property level for an article to be formed through a molded fiber formation process;
determine a physical profile for the article, the physical profile identifying a thickness and a ribbing structure that the article is to have to cause the article to have at least the intended physical property level while minimizing a volume of fibers used to form the article; and
generate a three-dimensional (3D) digital model of the article to have the determined physical profile.

15. A molded fiber toolset comprising:
a mold having holes; and
a screen having pores and an indentation, the screen to be mounted on the mold, wherein the mold and the screen are to be implemented to form a ribbing structure on a wet part formed of molded fibers through application of a suction force onto the wet part through the holes in the mold and the pores in the screen, wherein the suction force is to cause some of the molded fibers in the wet part to be pulled into the indentation and form into the ribbing structure on the wet part.
